(19) United States
(12) Patent Application Publication
(10) Pub. No.: US 2024/0423161 A1
(43) Pub. Date: Dec. 26, 2024

(54) METHODS AND SYSTEMS FOR STORING AND PROVIDING INFORMATION RELATED TO COMPANION ANIMALS

(71) Applicant: Unified Information Devices, LLC, Wilmington, DE (US)

(72) Inventors: Matthew Ruiter, Deerfield, IL (US); Craig Jordan, Kenosha, WI (US)

(73) Assignee: Unified Information Devices, LLC, Wilmington, DE (US)

(21) Appl. No.: 18/751,053

(22) Filed: Jun. 21, 2024

Related U.S. Application Data
(60) Provisional application No. 63/522,912, filed on Jun. 23, 2023.

(51) Int. Cl. A01K 11/00; A01K 29/00; G06K 7/10

(52) U.S. Cl. CPC A01K 11/006; A01K 29/005; G06K 7/10297

(57) ABSTRACT

A computer tagging system and computer-implemented method for programming a programmable component configured to be embedded in an animal, with user specified information relating to identification of the animal, in a second memory portion that is programmable to include the user specified information. A console component is communicatively coupled to a user interface and an RFID programming emitter. The console component, via the user interface, receive user entered information prescribing the user specified information relating to identification of the animal. A signal including the user specified information is transmitted from the RFID programming emitter to the programmable component located in proximity the RFID programming emitter. Responsive to receiving the transmitted signal from the RFID programming emitter, the user specified information is caused to be stored in the second memory portion of the programmable component.

### CROSS REFERENCE TO RELATED APPLICATIONS

This application claims priority to U.S. Patent Application Ser. No. 63/522,912 filed Jun. 23, 2023 which is incorporated herein by reference in its entirety.

### FIELD OF THE INVENTION

The illustrated embodiments relate to computer methods and systems for storing and providing information related to animals, and, more particularly, to methods and systems for storing and providing identification information and health information of companion animals.

### BACKGROUND OF THE INVENTION

Companion animals, or pets, are often very important to their owners, and are often the source of concern regarding both the safety and health of the animals. One of the biggest fears for an owner is his companion animal being lost. To help identify lost animals, various methods have been used, including collar tags imprinted with information related to the animal and/or the owner. Tags, however, can easily be removed or separated from the animal. Tattooing companion animals with a number, such as the companion animal owner's social security number, is another method of identifying companion animals, especially dogs.

Another means available to identify a companion animal is a system that includes the implanting of a microchip, transponder (electronic tag) or other similar identification device into the animal. When a lost animal is found, the animal can be scanned using, for example, a radio frequency identification (RFID) reader, which reads an identification number on the tag. Often, this identification number is regulated by ISO 11784 and 11785 standards for uniqueness of the ID's and universal scanning. The implanted tag thus provides a permanent, unique identifier that remains in place, so the when the companion animal is found, it can easily be identified and the owner can be notified. See, e.g., U.S. Pat. No. 5,211,129, the contents of which are hereby incorporated by reference herein.

If the found companion animal is injured or requires medical treatment, the companion animal may be taken to a local emergency care center or animal hospital. The emergency care center, however, will typically not have access to medical records of the animal and therefore may not be able to provide the best medical care required for the animal. A similar situation may arise when an owner is traveling away from home, for example, on vacation, with a companion animal. If the animal becomes ill or otherwise requires medical assistance, the owner may bring his/her animal to the nearest vet or animal shelter. The workers at these locations, however, will not have access to the medical records of the animal, and thus, may not be able to provide the best medical treatment to the animal.

Currently, with regard to above mention of the permanent ID's in an implantable microchip, the method for recovery of a lost pet requires the pet owner to register the RFID number into a national database. If an animal is microchipped but not registered with a national database, which often requires a periodic fee (e.g., $20/year per pet), the information cannot be retrieved (the unique RFID number is on the microchip, but is nevertheless no automatically updated into the database), whereby the pet will remain lost. Additionally, it is noted that when Veterinarians microchip an animal, it is left up to the owner to register the animal, which is not often done-many owners assume that if a pet is microchipped, the number is recorded in the database which is not the case.

Thus, there is a need to provide an easy system and method for remotely accessing medical providers, companion animal owners and others for information pertaining to medical conditions, treatments and procedures such as vaccinations, diseases and other health records of the companion animal.

### SUMMARY OF THE INVENTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, an onboard memory of a microchip implanted in an animal, typically already having a unique identifier, is further programmable to store user information added to the microchip. Preferably, the owner is then not required to register the unique identifier with a national database site. For instance, when scanned, an ID (e.g., an owner's and pet's name) and phone number will be identified to a user for fast pet recovery. Additionally, the programmable information can be periodically changed (e.g., by a veterinarian) by a user having a device capable of programming the microchip in the event the pet is transferred to a new owner and/or to update an animal's health records.

In certain aspects of the illustrated embodiments, described is a computer tagging system and computer-implemented method for programming a programmable component configured to be embedded/associated with an animal, with user specified information relating to identification of the animal. The user specified information preferably consists of one or more of: a phone number; pet name; owner name; an address; website address; vaccination status; preexisting ailments; insurance information; health/medical history; allergies and other known aliments.

The programmable component may be configured as capsule device configured to be embedded under a skin portion of the animal, or tagged to an external portion of the animal, such as an ear. Preferably, the programmable component is embedded under a skin portion of the animal or may reside external from the animal when the second memory portion of the programmable component is programmed with the user specified information. In certain embodiments, the programmable component further includes a temperature sensing device for determining a temperature of an animal.

The programmable component preferably includes a permanent Identification Number such that the programmable component preferably has a first memory portion that is not programmable which includes the permanent Identification Number, and a second memory portion that is programmable to include the user specified information. A console component is communicatively coupled to a user interface and an RFID programming emitter. The console component may be configured as either a handheld or fixedly mounted device. The console component includes one or more memory devices configured to store instructions thereon that, when executed by one or more processors, cause the one or more processors to enable the console component, via the user interface, to receive user entered information prescribing the user specified information relating to identification of the animal. A signal, including the user specified information relating to identification of the animal, is then caused to be transmitted from the RFID programming emitter to the programmable component located in proximity the RFID programming emitter. Responsive to receiving the transmitted signal from the RFID programming emitter, the user specified information is then caused to be stored in the second memory portion of the programmable component.

Certain other aspects include a RFID scanning device operatively associated with a display component, being operative and configured to scan the programmable component with a transmitted RFID signal to identify, via a returned RFID signal emitted from the programmable component, the user specified information stored in at least the second memory portion of the programmable component, via the display component. The RFID scanning device may be either a separate portable device relative to the console component or a is integrated as a unitary device with the console component.

In certain embodiments, the programmable component is configured and operative such that the second memory portion is periodically programmed to be updated with differing user specified information.

### BRIEF DESCRIPTION OF THE DRAWINGS

The accompanying appendices and/or drawings illustrate various non-limiting, example, inventive aspects in accordance with the present disclosure:

FIG. 1 depicts an example communication network used with illustrated embodiments;

FIG. 2 depicts an example network device/node used with illustrated embodiments;

FIG. 3 depicts an exemplary programming device, such as a console component, for programming a microchip in accordance with the illustrated embodiments; and

FIG. 4 depicts an exemplary scanning device for scanning a microchip in accordance with the illustrated embodiments.

### DETAILED DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Where a range of values is provided, it is understood that each intervening value, to the tenth of the unit of the lower limit unless the context clearly dictates otherwise, between the upper and lower limit of that range and any other stated or intervening value in that stated range is encompassed within the illustrated embodiments. The upper and lower limits of these smaller ranges may independently be included in the smaller ranges is also encompassed within the illustrated embodiments, subject to any specifically excluded limit in the stated range. Where the stated range includes one or both of the limits, ranges excluding both of those included limits are also included in the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims. All publications and references cited herein are expressly incorporated herein by reference in their entirety.

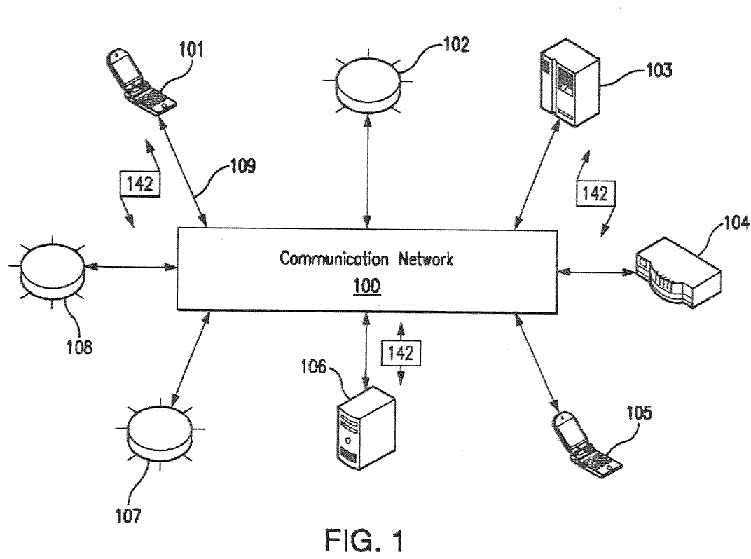

Turning now descriptively to the drawings, in which similar reference characters denote similar elements throughout the several views, FIG. 1 depicts an exemplary computer network 100 in which below illustrated embodiments may be implemented.

It is to be understood a computer network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example computer network 100 illustratively comprising nodes/devices 101-108 (e.g., sensors 102, client computing devices 103 (such as the below mentioned micro-chip programming device 300 and scanning device 400), smart phone devices 105, web servers 106, routers 107, switches 108, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Computer program instructions may be provided to a processor of a computer apparatus (e.g., an animal computer tracking system), or other programmable data processing apparatus to produce a machine, such that the instructions, which execute via the processor of the computer or other programmable data processing apparatus, create means for implementing the functions/acts specified in the flowchart and/or block diagram block or blocks.

It is to be appreciated that the computer network 100 may be an integrated component of the data management system illustrated and described in commonly assigned U.S. Pat. No. 11,375,693, the contents of which are incorporated by reference herein in its entirety.

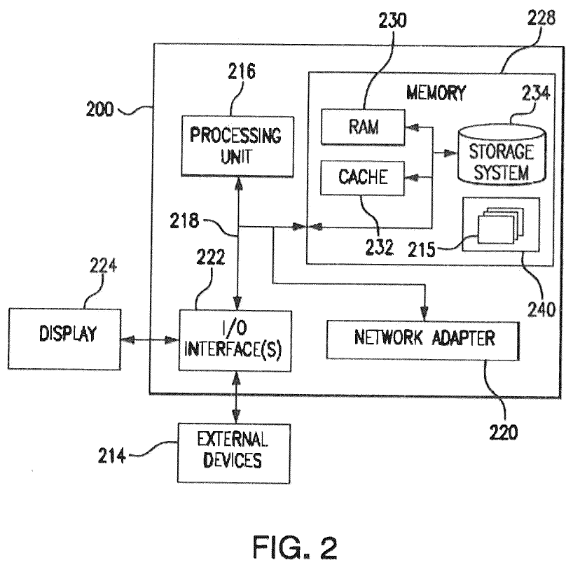

FIG. 2 is a schematic block diagram of an example network computing device 200 (e.g., client computing device 103, server 106, etc.) that may be used (or components thereof) with one or more embodiments described herein, e.g., as one of the nodes shown in the network 100. As explained above, in different embodiments these various devices are configured to communicate with each other in any suitable way, such as, for example, via communication network 100.

Device 200 is intended to represent any type of computer system capable of carrying out the teachings of various embodiments of the present invention. Device 200 is only one example of a suitable system and is not intended to suggest any limitation as to the scope of use or functionality of embodiments of the invention described herein. Regardless, computing device 200 is capable of being implemented and/or performing any of the functionality set forth herein. For instance, it is to be understood and appreciated each of the below described micro-chip programming device 300 and scanning device 400 may consist of one or more components of computing device 200. Further, each of devices 300 and 400 preferably couple to an electrical energy source for providing energization of processing unit 216 therein. For instance, such an energy source may be a battery source self-contained in each device 300 and 400.

Computing device 200 is operational with numerous other general purpose or special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, and distributed data processing environments that include any of the above systems or devices, and the like.

Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices.

Device 200 is shown in FIG. 2 in the form of a special purpose computing device, components of which are to be understood to be included the in below described micro-chip programming device 300 and scanning device 400 in accordance with the illustrated embodiments. The components of device 200 may include, but are not limited to, one or more processors or processing units 216, a system memory 228, and a bus 218 that couples various system components including system memory 228 to processor 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random-access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the invention.

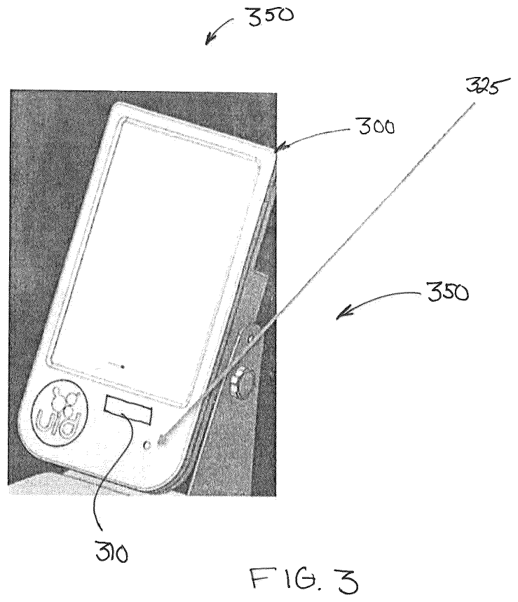

Program/utility 240, having a set (at least one) of program modules 215, for carrying out the functionality of the illustrated embodiments of FIGS. 3-5, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of embodiments of the invention as described herein.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which embodiments of the below described present invention may be implemented. FIGS. 1 and 2 are exemplary of a suitable environment and are not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

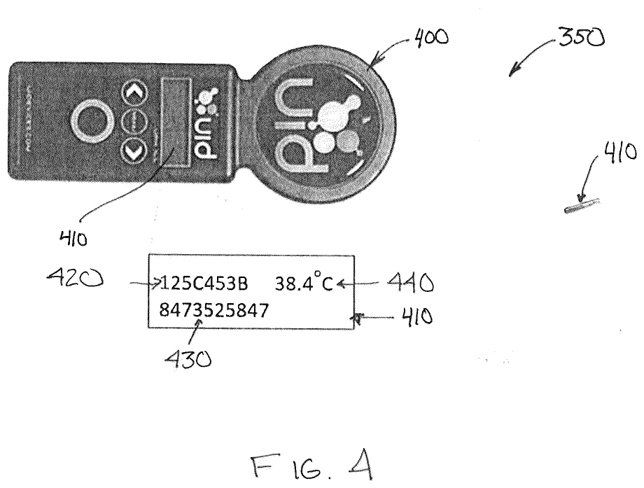

With the exemplary communication network 100 (FIG. 1) and computing device 200 (FIG. 2) being generally shown and discussed above, description of certain illustrated embodiments of the present invention will now be provided. With reference now to certain embodiments illustrated in FIGS. 3 and 4, it is to be appreciated that in accordance with the illustrated embodiments, described herein is a system and method for programming user selected information, such as pet owner name, phone number and other pet information (e.g., health records) preferably onto an ISO microchip, with or without, temperature sensing capabilities for enabling easy pet recovery and/or retrieval of relevant pet information (e.g., retrieval of health information, such as vaccination status and known ailments and allergies). Preferably, the illustrated embodiments enable onboard memory of an animal's/pet's microchip to be programmed to store the aforesaid user selected information to the microchip.

In accordance with the illustrated embodiments, described is an animal tagging system 350 that utilizes one or more components of the communication system 100 of FIG. 1, and one or more components of the computer device 200 of FIG. 2. In certain aspects of the illustrated embodiments, described is a computer tagging system and computer-implemented method for programming a programmable component configured to be embedded in an animal, with user specified information relating to identification of the animal. As described herein, the user specified information preferably consists of one or more of: a phone number; pet name; owner name; an address; website address; vaccination status; preexisting ailments; insurance information; health/medical history; allergies and other known aliments.

The programmable component 410 (FIG. 4) may be configured as capsule device configured to be embedded under a skin portion of the animal. In accordance with the illustrated embodiments, the programmable component 410 may be embedded under a skin portion of the animal or may reside external from the animal when the second memory portion of the programmable component is programmed with the user specified information, as described herein. And in certain embodiments, the programmable component 410 further includes a temperature sensing device for determining a temperature of an animal.

In accordance with the illustrated embodiments described herein, the programmable component 410 preferably includes a permanent Identification Number (420) such that the programmable component 410 preferably has a first memory portion that is not programmable which includes the permanent Identification Number (420), and a second memory portion that is programmable to include the user specified information (430).

The animal tagging system 350 includes a console component 300 is communicatively coupled to a user interface (e.g., 310) that may be either integrated with the console component 300, or located external of the console component (e.g., computer device 105) and an RFID programming emitter component 320. The console component 300 may be configured as either a handheld or fixedly mounted device (as is shown in the illustrated embodiment of FIG. 3). The console component 300 includes one or more memory devices 228 configured to store instructions thereon that, when executed by one or more processors 216, cause the one or more processors 216 to enable the console component 300, preferably via the user interface 310, to receive user entered information prescribing the user specified information (430, FIG. 4) relating to identification of the animal. A signal, including the user specified information relating to identification of the animal (430, FIG. 4), is then caused to be transmitted from the RFID programming emitter 320 to the programmable component 410 located in proximity the RFID programming emitter 320. Responsive to receiving the transmitted signal from the RFID programming emitter 320, the user specified information (430, FIG. 4) is then caused to be stored in the second memory portion of the programmable component 410. As illustrated in FIG. 3, the console component 300 is shown to have a micro-chip programming region 325 to which a programmable component 410 is placed in close proximity to for programming the programmable component 410 with the aforesaid user specified information.

Certain other aspects of the tagging system 350 include a RFID scanning device 400 operatively associated with a display component 410, being operative and configured to scan the programmable component 410 with a transmitted RFID signal to identify, via a returned RFID signal emitted from the programmable component 410, the user specified information (430, FIG. 4) stored in at least the second memory portion of the programmable component 410, preferably via the display component 410. The RFID scanning device 4100 may be either a separate portable device relative to the console component 300 or a is integrated as a unitary device with the console component 300 (not shown).

In certain embodiments, the programmable component 410 is configured and operative such that the second memory portion is periodically programmed to be updated with differing user specified information (430, FIG. 4) (e.g., with an update phone number associated with the owner of the animal).

In accordance with certain illustrated embodiments described herein, the micro-chip 410 preferably consists of a capsule device configured to be inserted under the skin layer of an animal (e.g., a dog or cat). Each capsule device 410 preferably emits a low frequency (LF) passive RFID identifier and may include a thermometer device for recording and transmitting both an RFID identifier and a core body temperate of the associated animal. Preferably, the RFID identifier in each capsule 410 is a fixed unique identifier that is software programmable so as to be programmed with an identifier (e.g., a serial number) that is uniquely associated with a particular animal, which is then used by with a national database, which often requires a periodic fee (as mentioned above) for identifying the animal when the unique identifier is registered. Thus, when a RFID scanning device (e.g., 400 (FIG. 4)) is used to transmit/receive RFID signals, the capsule device 410 when subject to that RFID signal emits a LF signal containing the unique RFID identifier of the capsule 410, as well as the core body temperature (440, FIG. 4) of the animal the capsule 410 is associated with (if the micro-chip/capsule 410) is equipped with temperature sensing capabilities.

It is to be appreciated the capsule device 410 is not to be understood to be limited to the above described capsule device 410 as it may be encompassed/constructed in various configurations and attached to any suitable portion of an animal/pet it is intended to be associated with. For instance, an RFID tag may be used that is attached to an ear of an animal. The tag may be attached to the ear using any suitable structure. In some advantageous embodiments, the tag does not need to have a power source and may be used as a wireless device. In one some embodiments, the tag may comprise passive elements such as an inductive element and a capacitive element. It is to be appreciated that any suitable electrical structures may be used for the inductive and capacitive elements which provide suitable inductive and capacitive behavior characteristics suitable for carrying out the functionality of the illustrated embodiments as described herein.

It is to be appreciated and understood that in accordance with the illustrated embodiments, a current ISO (International Organization for Standardization) Microchip/Capsules 410 has the ISO unique number in a locked portion of the memory of the microchip/capsule 410, wherein the permanent Identification Number may be regulated by ISO 11784 and/or ISO 11785 standards. However, there are more additional blocks, capable of being programmed, in the memory that are not currently read by ISO scanners. As described herein, the illustrated embodiments open these memory blocks for programming, while retaining the original locked portion having the aforesaid ISO unique number. For instance, a user, such as a veterinarian, will program the “opened” memory blocks of the capsule 410 with information specifically relating to the animal the programmable component (e.g., the capsule 410) is associated with (the “programmed data”). For instance, the programmed data may include (but is not limited to): a phone number; pet name; owner name; an address; website address; vaccination status; preexisting ailments; insurance information; health/medical history; allergies and other known aliments; and other pertinent information associated with the animal/pet. For instance, a user uploads the user's phone number onto the capsule 410 so that when read by a compatible RFID scanner 400 (as mentioned further below), the ISO Unique ID will show up as well as the owners phone number or contact information. In accordance with certain embodiments, the programmed data on the capsule 410 is protected by a custom algorithm or open to ISO 11784/11785.

The “programmed data and RFID number” could be added to a HF collar or external fixated device for duplicate data. This could be read by NFC on phones.

With specific reference to FIG. 3, a programming console 300 is provided that is preferably operatively associated with a user interface, and is specifically configured to program the capsule 410 with information specifically relating to the animal/pet the programmable component is associated with, as described above. It is appreciated that in accordance with the illustrated embodiments, the programming console 300 is preferably configured to program a capsule 410 that is either embedded in an animal or located external of an animal. Additionally, the programmable console/component 300 may be further adapted to be periodically/continuously program, so as to update/change, as desired by a user, aforesaid the programmed data specifically relating to the animal/pet the capsule 410 is associated with. The programming console 300 may be configured as either a handheld or fixedly mounted device.

As previously mentioned, the programmed data is intended to be read by a compatible (ISO data will be able to be read by all ISO 11785 readers). In accordance with the illustrated embodiments, a scanning device 400 is provided, that is preferably operatively associated with a display component, which is also preferably a RFID reader device. The scanning device 400 is configured to scan the capsule 410 to identify, via the display component, the programmed information stored in its memory, including its unique ID serial number (whether registered to a pet or not) relating to the animal capsule 410 is associated with. The scanning device 400 may also detect the temperature (440, FIG. 4) of the animal when the capsule 410 is equipped with a temperature sensing component.

In accordance with certain illustrated embodiments, the scanning device 400 may be a ISO 11785 complaint RFID reader device, and may be configured as either a handheld or fixedly mounted device.

Thus, certain advantages of the illustrated embodiments include an owner no longer being required to register a pet's embedded capsule 410 with a national database site for identifying a pet (as mentioned above), as the programmed information (e.g., the owner's ID and phone number) will appear on the scanning device 400, preferably via a display component 410 provided on the scanning device 400, enabling rapid pet recovery. And as also mentioned above, this programmed information may also be changed/updated by a user (e.g., by a veterinarian) that has access to the programming component/console 300 (e.g., in the event the pet is transferred to a new owner). Thus, information such as vaccine status, allergies, or other important information can be stored in the capsule/microchip 410, which may be readily accessed (e.g., by a suitable scanning device 400) enabling a rapid diagnosis for recovery or accessing health information.

It is envisioned, scanning devices 400 will be associated with relevant locations/facilities, such as pet stores, or in certain public areas providing scanning ability of a lost, or owned, pet for verification purposes. Additionally, veterinarian offices/clinics will have scanning devices 400 accessible at the time the animal enters the clinic. Thus, as an animal is placed next to a scanning device 400, the unique ID and aforesaid programmed information, as well as perhaps an animal's temperature (as mentioned above), is extracted from a capsule 410 embedded in the animal and sent to the clinic's software system for pre-registry of the animal. And in the event the animal does not already have an embedded capsule 410, a capsule 410 may then be embedded in the animal having the certain programmed information in accordance with the illustrated embodiments. Thus, advantages of the illustrated embodiments are numerous, including enabling rapid pet identification/recovery easier, as well as enabling a veterinary or clinic that is performing the microchipping to have the ability to program the programmed information directly into a microchip/capsule 410 associated with a certain animal.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of the illustrated embodiments, and not in limitation thereof.

For instance, certain embodiments may include a mobile application system for assistance with the identification and recovery of lost pets wherein the application receives input from the lost animal which assist with the identification of the animal. Thus, once the animal is identified or listed as to most probable identities, an alert system and/or additional information as to who the animal belongs to is provided to a finder, preferably via a user device, email, and/or telephony associated with the pet finder. The pet finder is then able to help get the found animal either to their owner or to a place of treatment or safety. In certain embodiments, the mobile application system is further configured to provide an alert notification and/or additional information to the pet animal owner regarding the found animal, wherein the notification and/or additional information is transmitted to the pet animal owner via a user device, email, and/or telephony associated with the pet animal owner.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A computer tagging system for programming a programmable component configured to be embedded in an animal, with user specified information relating to identification of the animal, wherein the programmable component includes a permanent Identification Number such that the programmable component has a first memory portion that is not programmable which includes the permanent Identification Number, and a second memory portion that is programmable to include the user specified information, comprising:
a console component communicatively coupled to a user interface and an RFID programming emitter, the console component including one or more memory devices configured to store instructions thereon that, when executed by one or more processors, cause the one or more processors to:
enable the console component, via the user interface, to receive user entered information prescribing the user specified information relating to identification of the animal;
cause a signal, including the user specified information relating to identification of the animal, to be transmitted from the RFID programming emitter to the programmable component located in proximity the RFID programming emitter whereby, responsive to receiving the transmitted signal from the RFID programming emitter, the user specified information is caused to be stored in the second memory portion of the programmable component.

2. The computer tagging system as recited in claim 1, further including a RFID scanning device operatively associated with a display component, operative and configured to scan the programmable component with a transmitted RFID signal to identify, via a returned RFID signal emitted from the programmable component, the user specified information stored in at least the second memory portion of the programmable, via the display component.

3. The computer tagging system as recited in claim 2, wherein the RFID scanning device is a separate portable device relative to the console component.

4. The computer tagging system as recited in claim 2, wherein the RFID scanning device is integrated as a unitary device with the console component.

5. The computer tagging system as recited in claim 1, wherein the console component is configured as either a handheld or fixedly mounted device.

6. The computer tagging system as recited in claim 1, wherein the programmable component is configured as capsule device configured to be embedded under a skin portion of the animal.

7. The computer tagging system as recited in claim 6, wherein the programmable component is embedded under a skin portion of the animal when the second memory portion of the programmable component is programmed with the user specified information.

8. The computer tagging system as recited in claim 6, wherein the programmable component is located external from the animal when the second memory portion of the programmable component is programmed with the user specified information.

9. The computer tagging system as recited in claim 1, wherein the programmable component further includes a temperature sensing device for determining a temperature of an animal.

10. The computer tagging system as recited in claim 1, wherein the user specified information consists of a phone number.

11. The computer tagging system as recited in claim 10, wherein the user specified information further consists of one or more of: pet name; owner name; an address; website address; vaccination status; preexisting ailments; insurance information; health/medical history; allergies and other known aliments.

12. The computer tagging system as recited in claim 1, wherein the programmable component is configured and operative such that the second memory portion is periodically programmed to be updated with differing user specified information.

13. A computer tagging system for programming a programmable component configured to be embedded in an animal, with user specified information relating to identification of the animal, wherein the programmable component includes a permanent Identification Number such that the programmable component has a first memory portion that is not programmable which includes the permanent Identification Number, and a second memory portion that is programmable to include the user specified information, comprising:
a console component communicatively coupled to a user interface and an RFID programming emitter, the console component including one or more memory devices configured to store instructions thereon that, when executed by one or more processors, cause the one or more processors to:
enable the console component, via the user interface, to receive user entered information prescribing the user specified information relating to identification of the animal;
store the user entered information in the one or more memory devices;
cause a signal, including the user specified information relating to identification of the animal retrieved from the one or more memory devices, to be transmitted from the RFID programming emitter to the programmable component located in proximity the RFID programming emitter whereby, responsive to receiving the transmitted signal from the RFID programming emitter, the user specified information is caused to be stored in the second memory portion of the programmable component; and
a RFID scanning device operatively associated with a display component, operative and configured to scan the programmable component with a transmitted RFID signal to identify, via a returned RFID signal emitted from the programmable component, the user specified information stored in at least the second memory portion of the programmable, via the display component.

14. The computer tagging system as recited in claim 13, wherein the RFID scanning device is a separate portable device relative to the console component.

15. The computer tagging system as recited in claim 13, wherein the programmable component is configured as capsule device configured to be embedded under a skin portion of the animal.

16. The computer tagging system as recited in claim 15, wherein the programmable component is embedded under a skin portion of the animal when the second memory portion of the programmable component is programmed with the user specified information.

17. The computer tagging system as recited in claim 15, wherein the programmable component is located external from the animal when the second memory portion of the programmable component is programmed with the user specified information.

18. The computer tagging system as recited in claim 1, wherein the programmable component further includes a temperature sensing device for determining a temperature of an animal whereby the RFID scanning is further operative and configured to detect a temperature signal included in the returned RFID signal emitted from the programmable component.

19. The computer tagging system as recited in claim 13, wherein the user specified information consists of one or more of: a phone number; pet name; owner name; an address; website address; vaccination status; preexisting ailments; insurance information; health/medical history; allergies and other known aliments.

20. A computer-implemented for programming a programmable component configured to be embedded in an animal, with user specified information relating to identification of the animal, wherein the programmable component includes a permanent Identification Number such that the programmable component has a first memory portion that is not programmable which includes the permanent Identification Number, and a second memory portion that is programmable to include the user specified information, comprising the steps:
receiving, by a processor coupled to a user interface and an RFID programming emitter, user entered information prescribing the user specified information relating to identification of the animal;
storing, by the processor, the user entered information in the one or more memory devices;
transmitting a signal, from the RFID programming emitter, the user specified information relating to identification of the animal retrieved from the one or more memory devices, to the programmable component located in proximity the RFID programming emitter whereby, responsive to receiving the transmitted signal from the RFID programming emitter, the user specified information is caused to be stored in the second memory portion of the programmable component.
